(19) United States
(12) Patent Application Publication
(10) Pub. No.: US 2012/0067231 A1
(43) Pub. Date: Mar. 22, 2012

(54) Loading and/or unloading die cutting cylinders

(76) Inventors: Michael Alan Vandenberg, Loveland, OH (US); Odis Lee Hicks, JR., Florence, KY (US)

(21) Appl. No.: 13/199,729

(22) Filed: Sep. 7, 2011

Related U.S. Application Data
(60) Provisional application No. 61/402,896, filed on Sep. 7, 2010.

(51) Int. Cl. B41F 19/02

(52) U.S. Cl. 101/26

(57) ABSTRACT

A revolving indexer for use in connection with a printing machine utilizing die cutting cylinders including a shuttle for sliding the die cutting cylinder out from the printing machine and printing web and a sliding shuttle deck for loading the die cutting cylinder into the revolving indexer is provided.

### CROSS REFERENCE TO RELATED APPLICATIONS

The present application claims the benefit under 35 U.S.C. §119 to U.S. Provisional Patent Application Ser. No. 61/402,896 filed Sep. 7, 2010 and titled “LOADING AND/OR UNLOADING DIE CUTTING CYLINDERS,” the disclosure of which is hereby incorporated by reference.

### BACKGROUND

In many industries, manufacturing equipment utilizes die cutting mechanisms such as die cutting cylinders. While die cutting cylinders (or formats) are very effective, their loading and/or unloading (or removing) creates operator injury risks and inefficiencies in the manufacturing process.

For example, a printing machine (or press) may include one or more continuous or intermittent moving webs. Some printing machines typically require printing and die cutting of a variety of substrates into printed matter having different lengths (e.g., repeats, formats) and/or dimensions in the longitudinal direction of the web. Example die cutting functions may include cutting, scoring, slitting and/or sheeting. These functions may be achieved using various types of engraved die cutting cylinders. These cylinders are extremely heavy and need to be installed by hand or the use of a die hoist. These cylinders are expensive and may contain sharp edges that may be easily damaged. Therefore, this is a key area for delays, risk of injury and down time for the printing machine.

Conventionally, the removal of die cutting cylinders, and/or replacement of magnetic die cutting cylinder on printing machines must occur while the machine is stopped and no product is being produced or webs being converted. Further, conventionally, the die cutting cylinders have to be carefully removed and lowered into a slot, and onto the web. This requires the press operator to reach over the machine lifting the die cutting cylinders, creating strain (and potential injury) on the operator's back, as well as potential for damage to the die and/or printing press.

Given these obstacles, typically only one die cutting cylinder can be replaced by an operator at a time. For example, when the amount of product meeting certain desired criteria has been satisfactorily created, various components including the die cutting cylinder may have to be removed to make room for the next format or die cutting cylinder. After placement of the new format, all components have to be replaced and secured before operations can resume.

Additional context regarding printing machines and cylinders is described in U.S. Pat. No. 5,711,225, the entire contents of which are herein incorporated by reference.

Therefore, it would be desirable to have an apparatus and/or method for loading and/or unloading die cutting cylinders in a safer and more efficient manner than provided by the prior art.

### BRIEF DESCRIPTION OF THE DRAWINGS

The foregoing and other features of the present disclosure will become more fully apparent from the following description and appended potential points of novelty, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a side elevational diagram depicting an example embodiment of the present invention;

FIG. 2 is a top perspective diagram depicting the example embodiment of FIG. 1;

FIG. 3 is a side perspective diagram depicting a portion of the example embodiment of the present invention depicted in FIG. 1;

FIG. 4 is a detail side perspective diagram depicting the shuttle portion of the example embodiment of the present invention as depicted in FIG. 3; and

FIG. 5 is a detail side perspective diagram depicting the cylinder portion of the example embodiment of the present invention as depicted in FIG. 3.

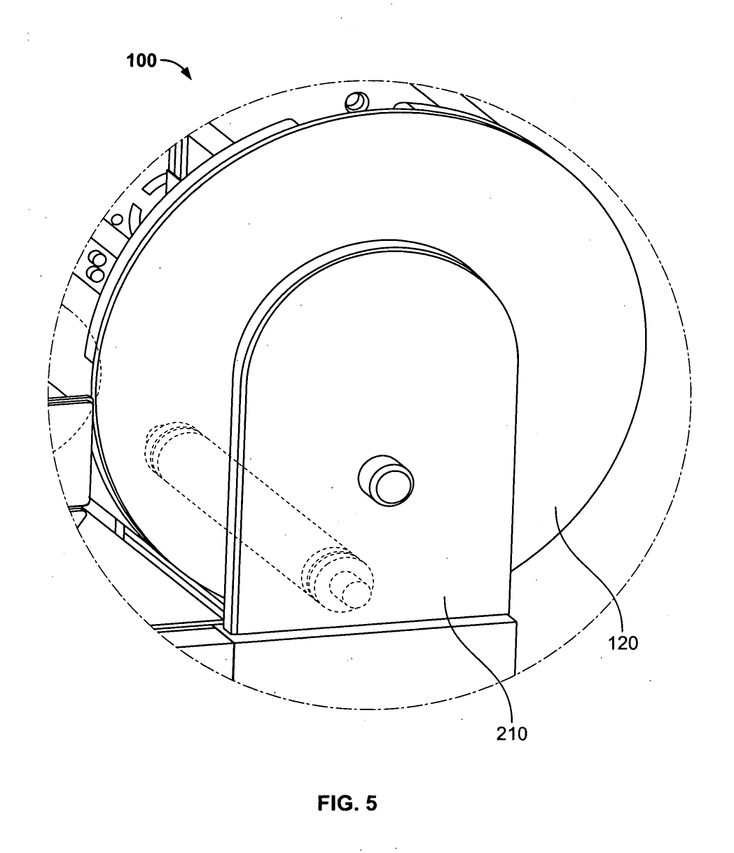

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and potential points of novelty are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

This disclosure is generally drawn to methods, systems, devices and/or apparatus related to changing die cutting cylinders. Specifically, the disclosed methods, systems, devices and/or apparatuses relate to loading and/or unloading die cutting cylinders from manufacturing machines such as printing machines in an effort to minimize injury risks and machine downtime.

The present disclosure contemplates that, on a printing press, a typical label is produced using printing and die cutting principles. Each label has a uniquely printed pattern and a matching die cut shape or could be finished by sheeting the web into individual sheets. The press operator may set up each printing station with the appropriate printing tools, inks, printing plates and die cutting cylinders. Each printing station would be set for proper color and impression, then placed in register with the previous station. After all stations (e.g., colors) have been satisfied the die cutting pressure is set and the waste matrix pulled from the web. Finally, the die cut register pattern is placed in register with the printed pattern. Production may then begin. After the job is completed and ready to start the next printed matter, all plate cylinders are removed, the inking systems that don't apply to the next job are removed and cleaned. The die cutting cylinder also has to be removed by first removing the pressure device, pressure assist device and finally the die cutting cylinder itself. This order is reversed to install the new die cutting cylinder and printing cylinders.

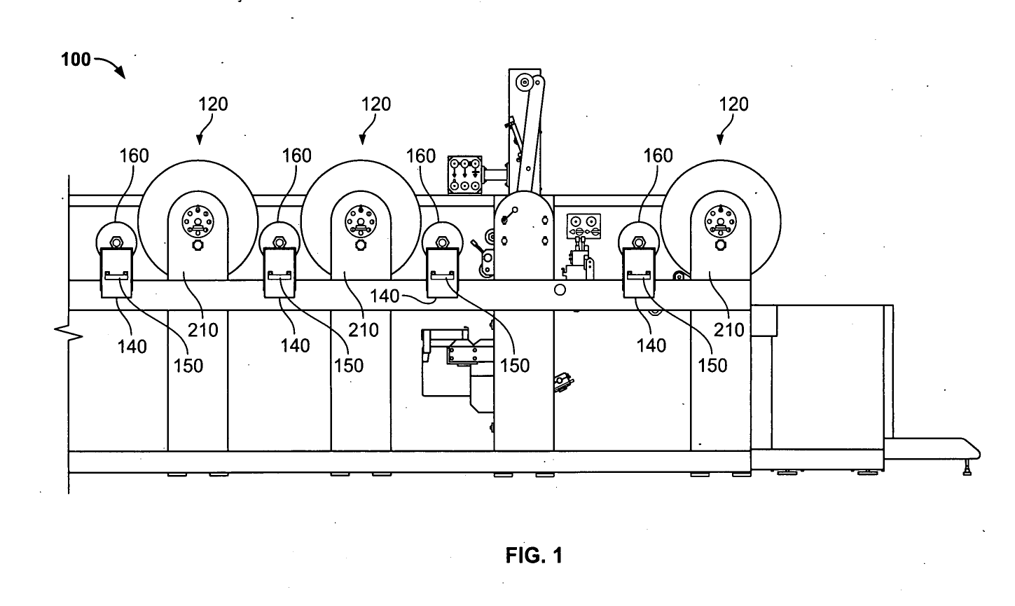

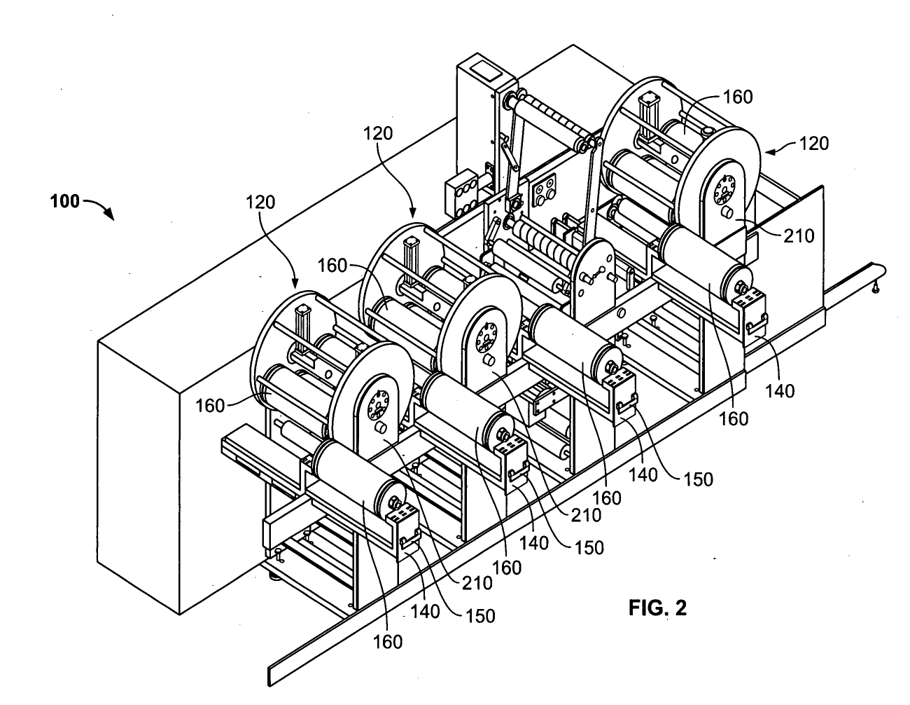

In an example embodiment, a printing machine of and/or operably coupled with a printing machine is provided. Some example printing machines 100 may provide one or more revolving indexers 120. For example, in FIGS. 1 and 2, a printing machine 100 having three revolving indexers 120 supported by revolving indexer side supports 210 is provided. Revolving indexers 120 may include one or more shuttles 140 for receiving and/or supporting die cutting cylinders 160. Shuttles 140 may be located before or after the revolving indexers 120. Shuttles 140 may be coupled to the printing machines 100 via a movement mechanism (e.g., sliding mechanism) as is known in the art. The shuttles 140 may be equipped with handles 150 to allow an operator to easily slide the shuttles 140 in and out to place a die cutting cylinder 160 in the revolving indexer 120. Example printing machines 100 provide the ability to switch die cutting formats or cylinders automatically and prepare or off load used formats while the machine is running production.

In the example embodiment, the printing machine 100 provides a shuttle 140 that extends outside the machine offering ergonomic placement and removal of formats in front of the operator rather then inside and/or on top of the machine. In some examples, the shuttle 140 may be slidably coupled to the printing machines 100. In this manner, each shuttle 140 may slide out from the printing machine 100 in a plane that is substantially perpendicular to the printing machine 100. FIG. 2 depicts one example where slidably coupled shuttles 140 extend from the printing machine 100.

In some examples, die cutting cylinders 160 may be loaded and/or unloaded with the assistance of a “push button” mechanism. Such push button mechanism may be performed by electro-mechanical means as is known in the art. In the embodiment disclosed herein, the actual loading/unloading of the die cutting cylinders 160 onto the shuttle 140 remains a manual process. However, switching of die cutting cylinders 160 may be assisted with the push of a button. Once a new die cutting cylinder 160 for the next job has been loaded onto the shuttle 140, the new die cutting cylinder 160 may be positioned (or switched) with a push button operation. This switching takes only seconds. The placing of die cutting cylinders 160 onto the shuttle 140 and returning the shuttle into the revolving indexers 120 may be done during production.

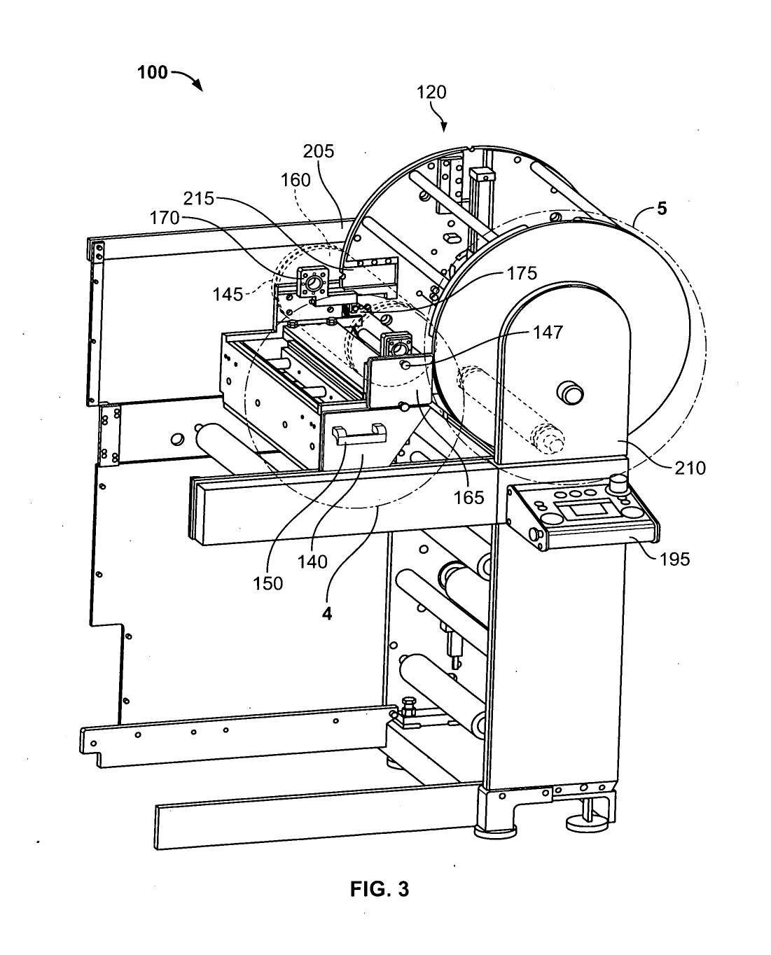

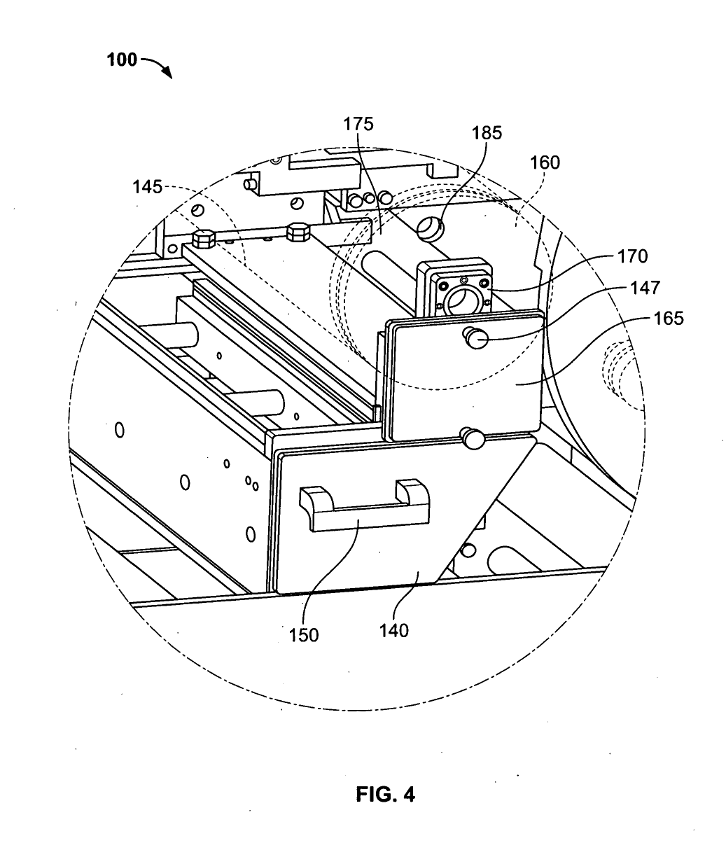

More specifically, as shown in FIGS. 3 and 4 (comprising detailed views of a revolving indexer 120 and shuttle 140 for use in connection with the present invention) the shuttle 140 may have a handle 150 on a side thereof, for facilitating outward sliding of the shuttle 140 for loading and unloading of die cutting cylinders 160 on the shuttle 140 by an operator, and a sliding shuttle deck 145 The sliding shuttle deck 145 may be slid inward and outward toward the revolving indexer 120 as is known in the art. The sliding shuttle deck 145 includes side ends 165 shaped to releasably receive pillow blocks 170 attached to the journal ends of the die cutting cylinder 160, and a latch mechanism 147 for releasably locating and holding the ends of the pillow blocks 170 during sliding and movement of the shuttle deck 145. The pillow blocks 170 preferably include locating pins 175 for being received in locating slots 185 of revolving indexer 120. Once the locating pins 175 are aligned with locating slots 185, shuttle deck 145 may be moved forward using the control panel 195, as is known in the art, so that the pillow blocks 170 are initially received in securement slots 205 located in the revolving indexer 120. Next, the latch mechanism 147 on the shuttle deck 145 is released and the die cutting cylinder 160 is slid into the revolving indexer 120 so that the pillow blocks 170 and locating pins are pushed all the way into their respective slots, 185, 205. The pillow block retainer 215 is then engaged to retain the pillow blocks 170, and thus the die cutting cylinder 160, in the revolving indexer 120. The revolving indexer 120, and appropriate die cutting cylinder 160, then may be rotated toward the web for use as is known in the art.

In some examples, a printing machine 100 provides the ability to stage multiple die cutting formats on the machine ready for use. This provides the ability to prepare for upcoming format changes. In this manner, example printing machines allow for the removal of used formats while the machine is running production, thus avoiding down time for the removal of used formats. Further, this allows the placement of new formats for upcoming and/or future production while the machine is running production, thus avoiding machine down time for installation of new formats.

In some examples, a method for loading and/or unloading die cutting cylinders is provided. Conventional methods may take up to 10 minutes to change die cutting cylinders, and may include the following steps:
Stop press
Remove pressure by backing off pressure screws
Remove pressure bridge
Remove assist roll
Remove die cutting cylinder (with use of die hoist if too heavy)
Install new die cutting cylinder (with use of die hoist if too heavy)
Install assist roll
Install pressure bridge
Apply pressure using pressure screws
Restart machine

However, a method for loading and/or unloading die cutting cylinders as disclosed in the present invention significantly reduces the time needed to change die cutting cylinders. In accordance with some example embodiments disclosed herein, die cutting cylinder changes may only take 5-10 seconds. An example embodiment in accordance therewith may include the following steps:
Stop machine
Remove pressure by touching “retract cylinder” button (e.g., hydraulic mechanism)
Press and hold “index” buttons until rotation is completed. This will position (or index) the pre loaded die cut cylinder into the cutting position and position the used die cutting cylinder into the unloading position.
Apply pressure by touching “extend cylinder” button
Start machine

Following from the above description and summaries, it should be apparent to those of ordinary skill in the art that, while the methods and apparatuses herein described constitute exemplary embodiments of the present invention, it is to be understood that the inventions contained herein are not limited to the above precise embodiment and that changes may be made without departing from the scope of the invention. Likewise, it is to be understood that it is not necessary to meet any or all of the identified advantages or objects of the invention disclosed herein in order to fall within the scope of the invention, since inherent and/or unforeseen advantages of the present invention may exist even though they may not have been explicitly discussed herein.

What is claimed is:

1. A printing machine utilizing replaceable die cutting cylinders comprising:
a revolving indexer rotatingly coupled to the printing machine in a position above a moving printing machine web, said revolving indexer adapted to releasably receive a die cutting cylinder therein;
a shuttle slidably coupled to the printing machine such that said shuttle may be slid in a direction transverse to the printing machine for loading and unloading of die cutting cylinders by an operator; and
a sliding shuttle deck slidably coupled to said shuttle, said shuttle deck adapted to releasably receive a die cutting cylinder thereon such that said shuttle deck may be slid towards said revolving indexer when said shuttle deck is loaded with a die cutting cylinder.

2. The printing machine of claim 1 further comprising two pillow blocks adapted to be mounted on opposite ends of a die cutting cylinder wherein said pillow blocks are shaped to be received in said shuttle deck and said revolving indexer.

3. The printing machine of claim 2 wherein said revolving indexer includes slots adapted to slidably receive said pillow blocks.

4. The printing machine of claim 3 wherein said pillow blocks include locating pins thereon adapted to be received by locating slots on said revolving indexer.

5. The printing machine of claim 1 wherein said shuttle includes a handle thereon.

6. The printing machine of claim 1 further comprising a control panel to control movement of said shuttle deck.

7. A printing machine comprising:
a moving web to be printed;
a die cutting cylinder;
a revolving indexer rotatingly coupled to the printing machine in a position above said web, said revolving indexer adapted to releasably receive a die cutting cylinder therein;
a shuttle slidably coupled to the printing machine such that said shuttle may be slid in a direction transverse to the web for loading and unloading of die cutting cylinders by an operator; and
a sliding shuttle deck slidably coupled to said shuttle, said shuttle deck adapted to releasably receive said die cutting cylinder thereon such that said shuttle deck may be slid towards said revolving indexer when said shuttle deck is loaded with a die cutting cylinder.

8. The printing machine of claim 7 further comprising two pillow blocks adapted to be releasably mounted on opposite ends of said die cutting cylinder wherein said pillow blocks are shaped to be received in said shuttle deck and said revolving indexer.

9. The printing machine of claim 8 wherein said revolving indexer includes slots adapted to slidably receive said pillow blocks.

10. The printing machine of claim 9 wherein said pillow blocks include locating pins thereon adapted to be received by locating slots on said revolving indexer.

11. The printing machine of claim 7 wherein said shuttle includes a handle thereon.

12. The printing machine of claim 7 further comprising a control panel to control movement of said shuttle deck.
